(19) United States
(12) Patent Application Publication
(10) Pub. No.: US 2006/0136361 A1
(43) Pub. Date: Jun. 22, 2006

(54) Extensible, customizable database-driven row-level database security

(75) Inventors: Jagan M. Peri, Redmond, WA (US); Jasjit Singh Grewal, Sammamish, WA (US); Michaeljon Miller, Bellevue, WA (US); Navin I. Thadani, Bellevue, WA (US); Tsvi M. Reiter, Redmond, WA (US); Youg Lu, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/020,468

(22) Filed: Dec. 22, 2004

(51) Int. Cl. G06F 17/30

(52) U.S. Cl. 707/1

(57) ABSTRACT

The method and system of the claims decomposes an organization structure into a set of mapping objects, where each mapping object represents an affiliation between entities of an organization. Each object in the data model is associated with an owner by designating a set of ownership affiliation attributes for each object. A set of privileges is assigned to an affiliation and access is checked based on a user's affiliation to an object and a user's privilege depth. Single privilege checking is performed only as a last resort for special, infrequent situations.

### FIELD OF THE INVENTION

The present invention generally relates to methods of providing secure access to database tables in a database management system.

### BACKGROUND OF THE INVENTION

Prior art customer relationship management (“CRM”) systems may rely on a security service provided by a computer operating system to secure CRM data. For example, some existing CRM systems leverage Microsoft Windows security functions to control access to CRM database objects. Windows security functions rely on security descriptors to determine access. Windows security descriptors contain access control entries which identify which users or groups may access a resource object of the Windows operating system. Microsoft Windows generally attaches a security descriptor to every system resource, e.g., computers, printers, etc., and provides security functions which can be called to indicate whether access is allowed based on a security descriptor, a requesting user, and an access request. Some CRM systems leverage the Windows security functions by attaching a security descriptor to CRM database objects. Because a CRM system may have its own user and group organizational model, including its own set of privilege and role structures, the Windows security descriptor may be modified to contain CRM entity specific roles and privileges. In order to adapt the Windows security descriptors to a particular CRM schema, the CRM system may map CRM specific entities to Windows system entities. The CRM system may then simply call the Windows security checking function.

Prior art systems that implement such a security descriptor customarily perform row-based security checking by retrieving the complete security descriptor for each row of interest. This is usually done using an application programming interface (“API”) to query a database. The API in turn, parses through each result set received from a database and checks each entity's security descriptor against a requesting user's security information to determine whether or not the user has access to the object and what type of access is allowed. In the case of a Windows operating system, one can use a Windows API to check CRM database object security descriptors.

While this patchwork security model is a convenient way of utilizing an existing operation system's security services, it is not scalable. The security descriptor implementation is appropriate for network resources whose numbers may be relatively small. For a CRM system database, the security descriptor size is directly related to the number of users and groups in a business, as well as the volume of business. As the organization and its businesses grow larger and more complex, the security descriptors may become excessively large and processing them may exhaust system processing resources very quickly.

Also, the existing security implementation is not extensible because it is highly dependent on a single operating system. In order to enable the CRM system to run on more than one operating system, a different security routine would have to be coded into the CRM system for each operating system. Moreover, changes to a CRM model are constrained by the operating system architecture because of the mapping between the CRM model and the operating system's security architecture.

Therefore, there is a need for an improved method and system of organizing security data in a CRM database to enable more independent and efficient security checking.

### SUMMARY

The method and system of the claims implements a completely data-base driven security model in order to free a CRM system from any dependence on a particular operating system. The security model allows for implementing various CRM systems and is extensible to create new roles and privileges.

The method and system of the claims decomposes an organization structure into a set of mapping objects, where each mapping object represents an affiliation between entities of an organization. Each object in the data model is associated with an owner by designating a set of ownership affiliation attributes for each object. Sets of privileges are assigned to affiliations and access is checked based on a user's affiliation to an object and a user's privilege depth. Single privilege checking is performed only as a last resort for special, infrequent situations, and access checking is processed much faster.

While the specific method and system will be described to apply to a CRM system embodiment, it is emphasized that this system may be applied to other secure application databases that uses hierarchical role models.

### BRIEF DESCRIPTION OF THE DRAWINGS

FIG. 1 illustrates a block diagram of a computing system that may operate in accordance with the claims;

FIG. 2 illustrates a common security descriptor used to implement row-based security;

FIG. 3 illustrates a processing diagram for a prior art security checking procedure;

FIG. 4 illustrates an ownership hierarchy typical in a CRM system and in computer operating systems and further illustrates a decomposition of the affiliation/ownership hierarchy;

FIG. 5 illustrates a security procedure implemented using an embodiment of the claims;

FIG. 6 illustrates a data model that may be used in an embodiment of the pending claims; and

FIG. 7 illustrates an extensibility enhancement to the data model of FIG. 6.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

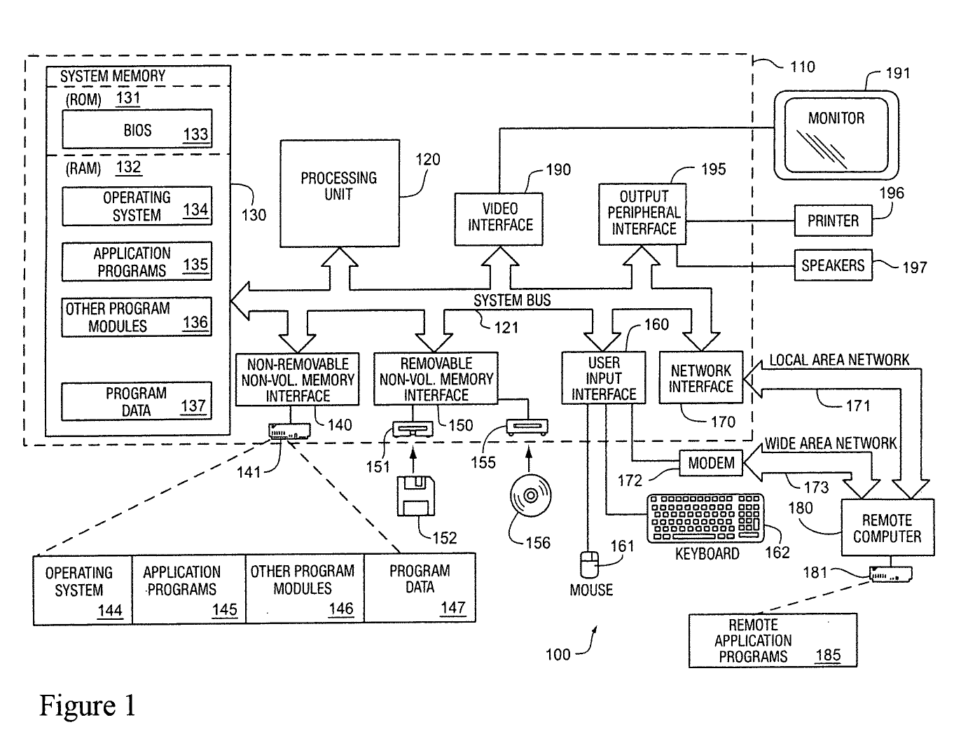

FIG. 1 illustrates an example of a suitable computing system environment 100 on which a system for the blocks of the claimed method and apparatus may be implemented. The computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

The blocks of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The blocks of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

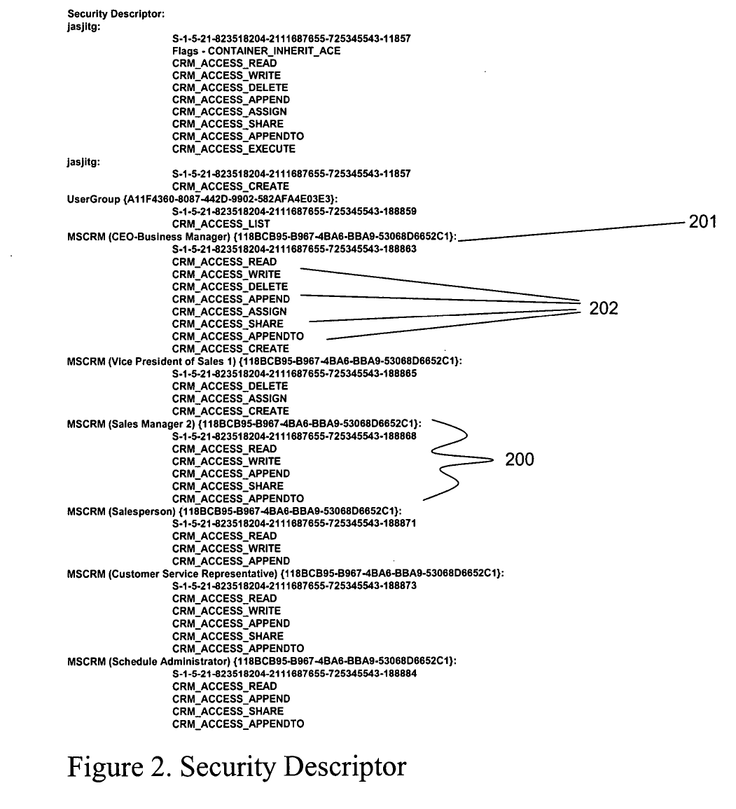

FIG. 2 illustrates a typical security descriptor used in a Microsoft Windows operating system adapted for a Microsoft CRM application. The security descriptor comprises at least one access control entry (“ACE”) 200, which shows a role 201 and a set of privileges 202. The privileges assigned to each role may include read, write, create, delete, assign, share append, append to, and execute privileges. This security descriptor uses access-only ACEs in which every role that has access to the object is listed in the descriptor along with the types of access allowed for that role. Alternatively, a deny-only ACE may comprise entries of each entity not allowed to access, in a particular manner, the database object. In this case, instead of privileges for access, the roles would list privileges not allowed.

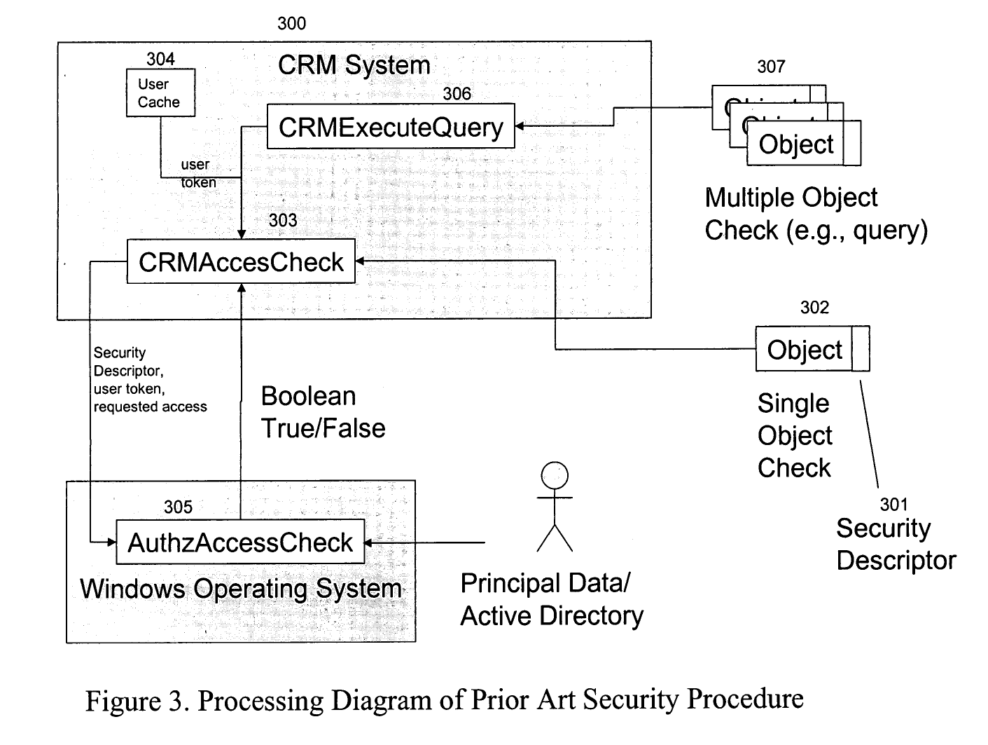

FIG. 3 illustrates a processing diagram for a prior art security checking procedure. A typical CRM system 300 may use a security data model which attaches a security descriptor column 301 to each secured CRM database object 302. In this particular system, a single CRM system API, CRMAccessCheck 303, is used to check access for the object 302. CRMAccessCheck 303 collects the security descriptor 301 of the object 302, user information from a cache 304, and the requested access, and in turn calls a Microsoft Windows system API, AuthzAccessCheck 305. AuthzAccessCheck 305 checks the current user's information against the security descriptor 301 and the type of access being requested to determine if the user has that level of access to the object. AuthzAccessCheck 305 returns a Boolean indicating whether the access is authorized. FIG. 3 also illustrates a typical query function 306 implemented by the CRM system 300. Queries often involve selection of multiple objects 307 for viewing. Consequently, a query function 306 may simply iterate over the CRMCheckAccess 303 function, passing in the additional limitation of a read-only privilege check (queries are used primarily for viewing objects only).

In a CRM system, each database object is usually created by a user, or owner, who may have a set of affiliations with other users and business units, or groups. In existing systems such as the one illustrated in FIG. 3, security checking is based on matching each role to a user and then checking each privilege assigned to the role to see if one matches the access requested. These existing systems fail to recognize that there may be affiliations within an organization that demand the same set of privileges. Consequently, privileges can be aggregated and checked by a privilege set, or privilege depth, rather than checked separately and individually. Because security checking does not go down to the individual privilege level for each object each time security is checked, security checking efficiency may be improved by checking recognized privilege sets (corresponding to affiliations) before resorting to checking individual privileges.

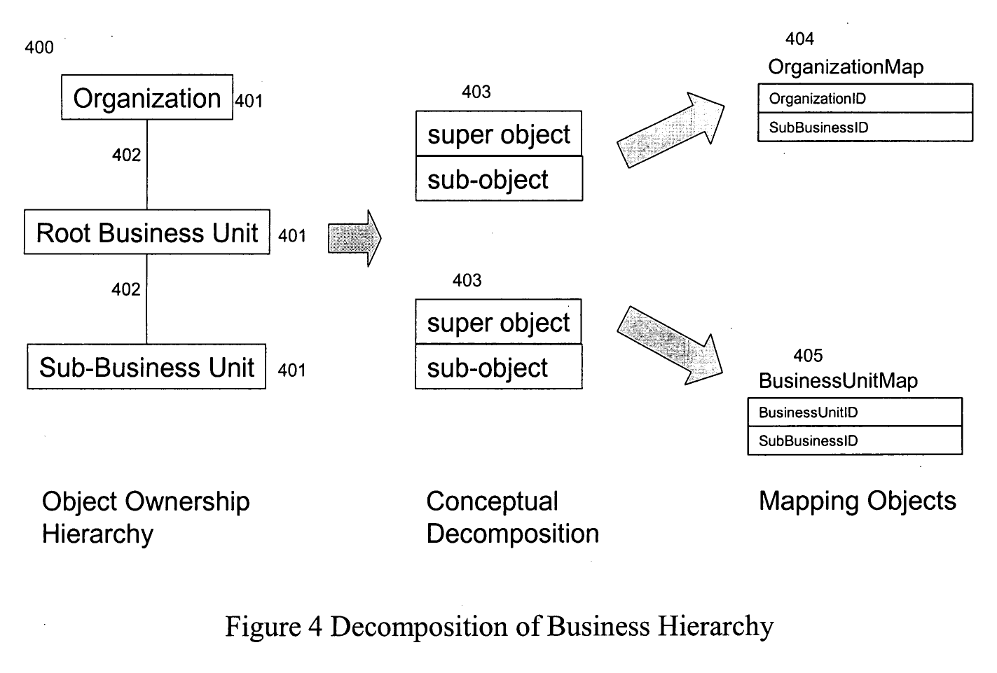

The method and system of the claims may be implemented by first taking an existing business organization and modeling each affiliation within the organization as a mapping object. This process may be illustrated in FIG. 4, which illustrates a typical organization chart 400 for a business. Each link 401 between levels 402 of an organization hierarchy represents an affiliation, and each affiliation may be modeled in a database as a mapping object 403, or table. Because most business organizations may be modeled using some form of the simplified hierarchical structure of FIG. 4, most business organizations using a CRM system may be modeled using the mapping objects. For the two-tier hierarchical model 400, FIG. 4 further illustrates an OrganizationMap object 404 and a BusinessUnitMap object 405 which capture the affiliation between an organization and a business, and between a business and a sub-business, respectively. It should be noted that any number of hierarchical tiers may be modeled by adding more mapping objects, or mapping tables.

In an implementation of the method and system of the claims, parameter identifiers may be designated for each object in the data model. These parameter identifiers correspond to an affiliation between the object and its owner. Thus, each object will have at least one designated owner attribute since each object will have at least one owner. Each owner may further be affiliated with another entity or group and each affiliation carries a set of privileges. Because privilege sets may be common among certain affiliations, access may often be granted to a user based solely on the user's affiliation to an object. Thus, security checking can be processed on a per object basis based on sets of privileges rather than individual privileges. For example, if there is an affiliation between a user and an object owner, then a particular set of privileges may be granted, depending further on whether the user carries the necessary privilege depth corresponding to that affiliation.

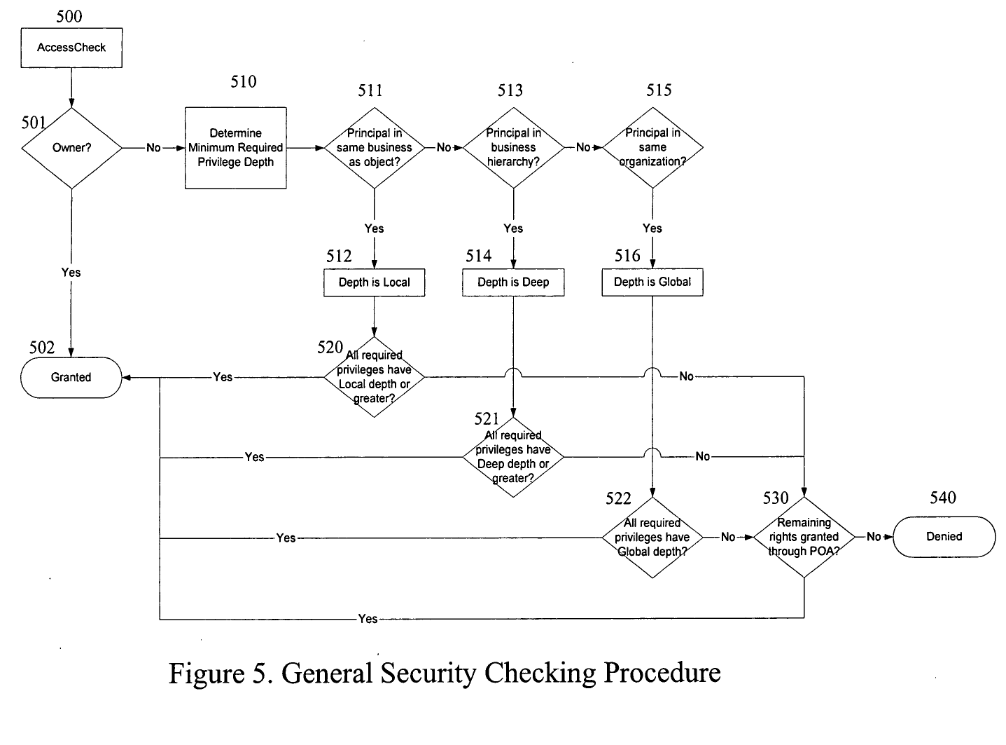

An embodiment of a security checking procedure of the method and system of the claims is illustrated in FIG. 5. Access checking procedure 500 first determines if the user is an owner of the object, as illustrated in block 501. If so, then the user has complete access in block 502. If the user is not an object owner, a routine of block 510 determines the required privilege depth to access the object based on the object's ownership hierarchy. If, at block 511, the user and object are determined to belong to the same business unit, then the minimum depth is Local 512. If, at block 513, the object's owning business unit is determined to be in the same hierarchy as the user's business unit, then the minimum required depth is Deep 514. If, at block 515, the object is determined to be in the same organization as the user, then the minimum required depth is Global 516. Once the minimum privilege depth is calculated, blocks 520, 521, and 522 check to see if the user's privileges have the minimum required depth. If the user's privileges have minimum required depth or greater, as determined in blocks 520, 521, and 522, access is granted in block 502. If not, routine 500 then determines, in block 530, if the object is explicitly shared to the user or a team of which the user is a member. If so, then access is granted in block 502, otherwise access is denied in block 540.

The privilege depth illustrated in FIG. 5 is categorized as basic, local, deep, or global. A user with a basic privilege depth has rights to any objects that are owned by that user, shared to that user, or shared to a team of which the user is a member. A user with a local privilege depth has rights of a basic privilege depth and also has rights to any objects that are in the user's business unit. A user with a deep privilege depth has rights of a local privilege depth and also has rights to any objects that are in sub-businesses of the business-unit to which the user belongs. This includes sub-businesses at any depth, not just an immediate level sub-business, and thus, includes sub-businesses of sub-businesses. A user with a global privilege depth has rights to any objects in the user's organization (and thus global is a superset of all the other privilege levels). The privilege depth assignments may vary depending on a particular CRM system.

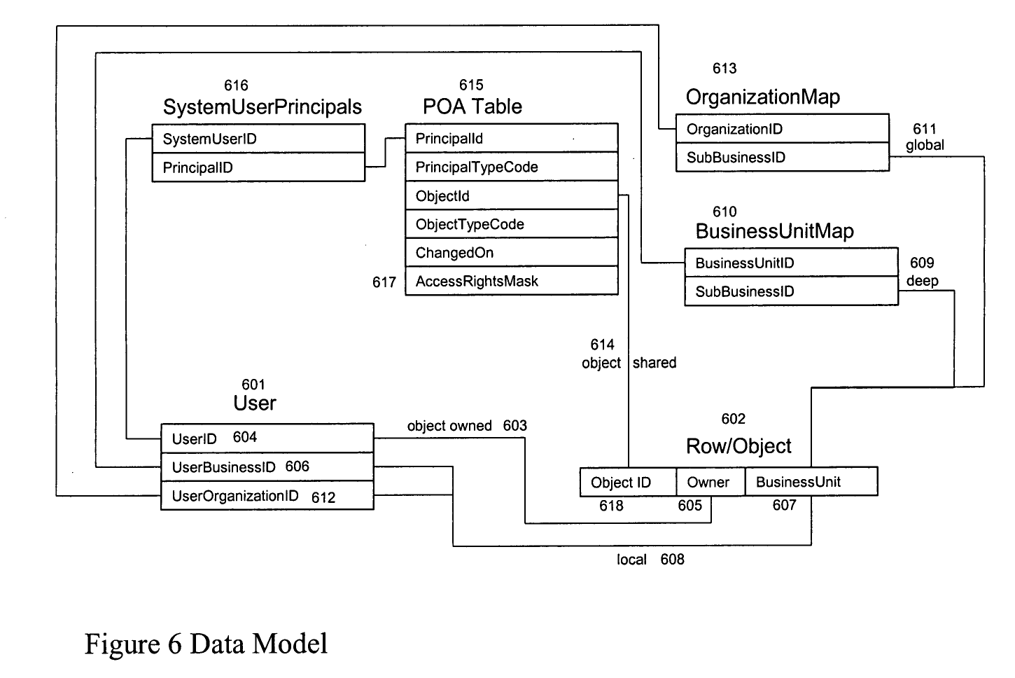

A data model embodiment of the system of the pending claims is illustrated in FIG. 6. FIG. 6 illustrates the objects required to implement the organization structure of FIG. 4 and the security procedure embodiment of FIG. 5. User 601, is requesting access to row/object 602. According to the security checking procedure of FIG. 5, direct ownership is first checked 603 by comparing userID 604 and object owner 605. Next, the business unit of the user 606 and object 607 are checked 608. This requires a privilege depth of local. While the data model shows a separate affiliation attribute for business unit 606, it should be noted that a separate mapping object may be used to connect an object owner 605 to an object owner's business unit. Subsequently, sub-business unit affiliation is checked 609 by comparing object business unit 607 and user business unit 606 via mapping BusinessUnitMap object 610. This check also requires a deep privilege depth. Business to organization affiliation access is checked 611 by comparing object business unit 607 and user organization unit 612 via OrganizationMap object 613 and requires a global privilege depth. Lastly, the object is checked 614 against a principal object access table (POA) 615 and a SystemUserPrincipals table 616 to determine if there is any explicit share privilege associated with the user. If none of the prior described conditions are fulfilled, access is denied to the object.

In FIG. 6, the POA table 615 in combination with the SystemUserPrincipals 616 is used to represent a self-mapping or a team mapping that enables the system of the claims to determine whether a single privilege (contained in the AccessRightsMask 617) is allowed for a particular object 602, based on the Object ID 618. Object ID 618 may be a primary key, for example. While this per-row, per-privilege checking 614, may be performed by the system, this check is performed, if at all, only after the affiliation checking is performed as illustrated in the conditional flow chart of FIG. 5. Also, it should be emphasized that while some existing systems such as those using security descriptors solely perform per-row, per-privilege checking, the method and system of the claims performs the checking procedure in tiers such that per-row, per-privilege checking may never be performed. Further, the checking procedure of the claims is tiered so that more probable affiliation matching conditions are performed in an order of decreasing probability of matching, where the least probable, most labor intensive matching check is performed later in the process. This increases the speed at which checking can be performed because it is less likely that there will be situations that require the most process consuming level of checking, i.e., per privilege checking.

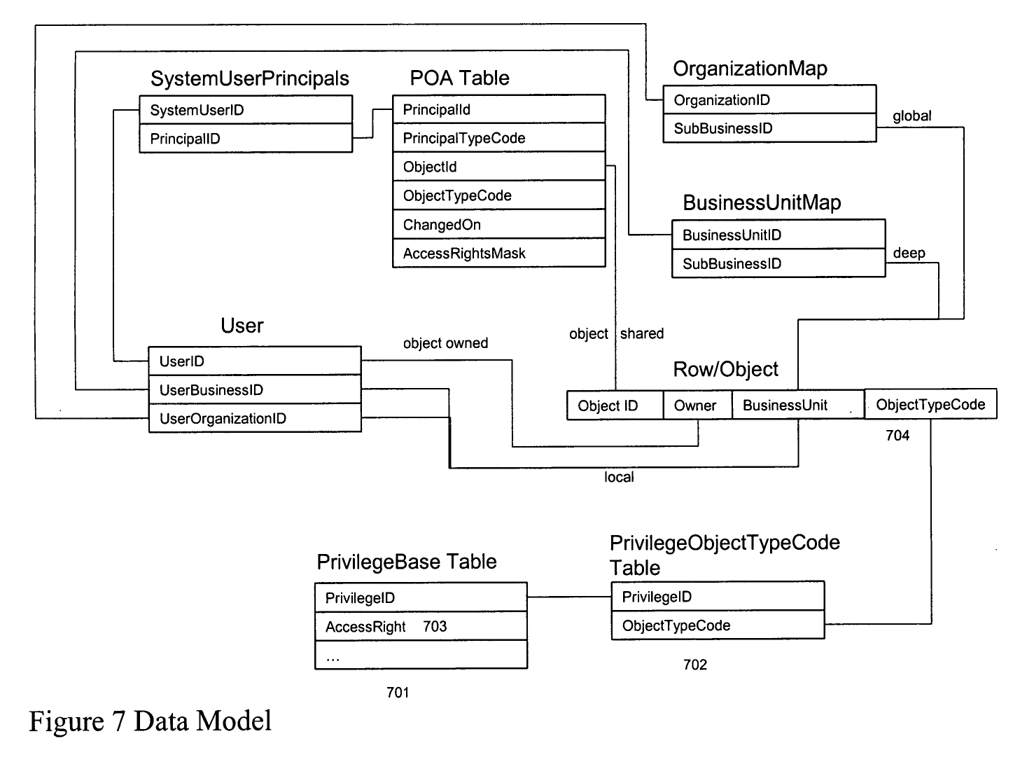

A further embodiment of the claims is illustrated in FIG. 7, which illustrates the PrivilegeBase table 701, PrivilegeObjectTypeCodes Table 702, and ObjectTypeCode attribute 703. These tables are used to provide extensibility to the security data framework by allowing the data model to handle defining and adding new privileges to new object types. The PrivilegeBase table 701 defines a set of attributes for a new privilege. The set of attributes may include an AccessRight parameter 704, indicating a type of access. The ObjectTypeCode 703 is used to designate a new group of objects. PrivilegeObjectTypeCodes 703 maps a specific privilege to an entity whose security it manages (ObjectTypeCode 703). This set of tables enables any new privilege to be created and to be associated with an object type created by the CRM application.

A SQL statement that may be used to implement the security process of FIG. 6 is shown below. It should be noted that an extra conditional could be added to enable new security privilege checking using the PrivilegeObjectTypeCodes table of FIG. 7.

```
  SELECT [Account columns to retrieve]
  FROM Account
  WHERE
  (
    -- object owned by the user
    Account.OwningUser = [Current User ID]
      or
    -- object owned by business unit of user - local access
    Account.OwningBusinessUnit = [Current User Business ID]
    -- role based access
      or
      -- deep access
      (Account.OwningBusinessUnit in Select biz.SubBusinessId from
BusinessUnitMap as biz where biz.BusinessId = u.BusinessUnitId)
and PrivilegeDepth = [Deep]
      or
      -- global access
      (Account.OwningBusinessUnit in Select org.SubBusinessId from
OrganizationMap org where org.OrganizationId = u.OrganizationId)
and PrivilegeDepth = [Global]
      or
  )
    -- object shared to the user
    or
    Account.AccountId in
    (
    select POA.ObjectId from PrincipalObjectAccess POA
    join SystemUserPrincipals sup on POA.PrincipalId = sup.PrincipalId
    where sup.SystemUserId = [Current User ID] and
    POA.ObjectTypeCode = 2 AND
    (POA.AccessRightsMask & 1) = 1
    )
```

As illustrated by the FIGS. 1-7, security is performed based on whether a user is affiliated with an owner of the object. The basic level check simply involves determining if the user is the owner of the object, in which case the user will have all privileges to the object. However, other affiliations exist between a user the object owner, in which case a different privilege depth is required for access. Further, a user may be affiliated with other groups or teams that have an ownership affiliation with the object. Simple membership into an explicit share group entitles the user to the individual privilege for that affiliation. This is also a means for overriding the general affiliation access checking and is used as a later conditional within the security checking procedure. As a further embodiment, an additional mapping object may be added to map new object groups demarcated by an object type code to a newly created privilege.

The method and system of the pending claims provides an access checking method that is based on ownership affiliations between objects and users. Further, the method and system of the claims orders the checking procedure so that the more probable, least labor intensive affiliation matching conditions are performed before the less probable, most labor intensive per-privilege matching check is performed. The method and system of the claims provides row-based security checking as a last resort override to the affiliation-role based security checking.

Unlike existing security models that use a security descriptor field to provide bulk instructions for API-based security processing, the present claims may rely on a security model that only references discrete ownership attributes of each database object, attributes that are often already part of the general attribute structure of the object. The hierarchy may be processed in an order that is determined based on overriding factors, which have greater probability of access granting. In this way, processing may be faster. Furthermore, because the security model of the claimed method and system processes the rows completely in a DBMS, rather than relying on an API, processing may be faster because a dedicated DBMS processing internal instructions will most often be faster than an API retrieving a set of rows over a communication channel and interpreting a large security descriptor.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments may be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A computer-readable medium having computer-executable instructions for performing database-driven, row level security comprising:
designating an object affiliation attribute for each secured object in the database object model;
creating a mapping object representing an ownership affiliation in an object hierarchy, wherein the mapping object comprises a user affiliation attribute and an object affiliation attribute; and
granting access to an object when an affiliation attribute of the user and an affiliation attribute of the object is contained in the mapping object.

2. The computer-readable medium of claim 1, wherein designating an object affiliation attribute comprises designating as an object affiliation attribute one of the set comprising an object identifier, an object owner, and an object business unit, and further wherein an affiliation attribute of a user comprises one of the set comprising a user identifier, a user business unit, and a user organization.

3. The computer-readable medium of claim 2, further comprising granting a user access to an object when a user identifier attribute of the user corresponds to an affiliation attribute of the object.

4. The computer-readable medium of claim 2, further comprising granting a user access to an object when a user business unit attribute of the user corresponds to an object business unit attribute of the object.

5. The computer-readable medium of claim 2, wherein the mapping object is a business unit mapping object comprising a user business unit attribute and an object business unit attribute.

6. The computer-readable medium of claim 2, wherein the mapping object is an organization mapping object comprising a user organization attribute and an object business unit attribute.

7. The computer-readable medium of claim 5, further comprising granting a user access to an object when a user business unit attribute of a user and an object business unit attribute of the object are contained in the business unit mapping object.

8. The computer-readable medium of claim 6, further comprising granting a user access to an object when a user organization attribute of a user and an object business unit attribute of the object are contained in the organization mapping object.

9. The computer-readable medium of claim 2, further comprising a user principal mapping object comprising a user identifier attribute and a principal identifier attribute, and a principal object mapping object comprising at least a principal identifier attribute and an object identifier attribute.

10. The computer-readable medium of claim 9, further comprising granting a user access to an object when a principal identifier attribute of a user principal mapping object corresponds to a principal identifier attribute of a principal object mapping object, and the user principal mapping object contains a user identifier attribute of the user and the principal object mapping object contains an object identifier of the object.

11. The computer-readable medium of claim 1, wherein the granting a user access to an object further comprises sending an SQL command to a database management system, the SQL command containing a WHERE clause that determines whether the mapping object contains an affiliation attribute of the user and an affiliation attribute of the object.

12. The computer-readable medium of claim 2, further comprising associating a privilege depth to an ownership affiliation in the object hierarchy and further wherein the granting a user access to an object further comprises determining whether a user has a privilege depth at least as deep as a privilege depth of the ownership affiliation represented by the mapping object.

13. The computer-readable medium of claim 12, further comprising granting a user access to an object when one of:
a user business unit attribute of the user corresponds to an object business unit attribute of the object and the user privilege depth is a local designation;
a user business unit attribute of a user and an object business unit attribute of the object is contained in a business unit mapping object and when the user privilege depth is a deep designation; and
a user organization attribute of a user and an object business unit attribute of the object is contained in an organization mapping object and when the user privilege depth is a global designation.

14. A computer system comprising:
an operating system providing a user authentication service;
a database management system for managing a set of databases, the database management system using the user authentication service to authenticate a user connecting to the database management system;
a customer relationship management system;
a customer database accessed by the customer relationship management system through the database management system;
an object in the customer database having an affiliation attribute;
a mapping object in the customer database representing an ownership affiliation in an object hierarchy, wherein the mapping object comprises a user affiliation attribute and an object affiliation attribute.

15. The system of claim 14, wherein the user affiliation attribute comprises one of the set comprising a user identifier, a user business unit, and a user organization, and further wherein the object affiliation attribute comprises one of the set comprising an object identifier, an object owner, and an object business unit.

16. The system of claim 15, wherein the mapping object comprises a business unit mapping object comprising a user business unit attribute and an object business unit attribute, and an organization mapping object comprising a user organization attribute and an object business unit attribute.

17. The system of claim 15, further comprising a user principal mapping object comprising a user identifier attribute and a principal identifier attribute, and a principal object mapping object comprising at least a principal identifier attribute and an object identifier attribute.

18. The system of claim 14, further comprising a privilege mapping object comprising an object type attribute and a privilege identifier attribute, wherein the privilege identifier corresponds to a privilege object.

19. The system of claim 14, wherein authentication service assigns the user at least one of a user identifier, a user business unit, and a user organization.

20. A computing apparatus, comprising:
a display unit that is capable of generating video images;
an input device;
a processing apparatus operatively coupled to said display unit and said input device, said processing apparatus comprising a processor and a memory operatively coupled to said processor;
a network interface connected to a network and to the processing apparatus;
said processing apparatus being programmed to:
create a set of mapping objects that represent an affiliation in a customer relationship management system object hierarchy, wherein each mapping object of the set of mapping objects comprises an object affiliation attribute and a user affiliation attribute; and
granting a user access to an object based on whether a mapping object shows a relationship between an affiliation attribute of the user and an affiliation attribute of the object.
